(19) United States
(12) Patent Application Publication
(10) Pub. No.: US 2016/0039174 A1
(43) Pub. Date: Feb. 11, 2016

(54) Elastic Feature Product

(71) Applicant: KUN-HAI WU, New Taipei City (TW)

(72) Inventor: KUN-HAI WU, New Taipei City (TW)

(21) Appl. No.: 14/920,879

(22) Filed: Oct. 23, 2015

Related U.S. Application Data
(63) Continuation-in-part of application No. 13/802,807, filed on Mar. 14, 2013.

(51) Int. Cl. B32B 5/26; B32B 27/32; A41D 31/02; B32B 5/18; B32B 7/12; B32B 5/02; B32B 27/36; B32B 27/40

(52) U.S. Cl. CPC B32B 5/26; B32B 27/36; B32B 27/322; B32B 27/40; B32B 5/18; B32B 7/12; B32B 5/026; B32B 5/024; A41D 31/02; B32B 2437/00; B32B 2307/304; B32B 2307/51

(57) ABSTRACT

An elastic feather product includes a plurality of elastic fabric layers, a plurality of elastic film layers respectively attached to an combined with the elastic fabric layers, a plurality of combination sections formed by combining localized areas of the elastic film layers in a gap-free and void-free manner, a receiving space delimited between and surrounded by the elastic fabric layers and the elastic film layers, and a stuffing layer fixed in the receiving space. With the elastic film layers attached to the elastic fabric layers to separate them from the stuffing layer and due to the elastic film layers being combined in a gap-free manner by the combination sections, the stuffing layer is fixed without using a sewing line (for the combination sections taking the place of a sewing line or stitching) so as to prevent outwards penetration of feathers of the stuffing layer.

### CROSS-REFERENCE TO RELATED APPLICATION

This is a continuation-in-part of co-pending U.S. patent application Ser. No. 13/802,807 filed on Mar. 14, 2013 and owned by the present applicant.

### TECHNICAL FIELD OF THE INVENTION

The present invention relates to an elastic feather product that comprises a stuffing layer that is securely fixed and is prevented from outward penetrating and that is thinned and has excellent elasticity to achieve better body fitting and enhanced effect of warm keeping.

### DESCRIPTION OF THE PRIOR ART

A feather/down clothing product generally comprises a layer of feather and/or down, or other stuffing having an excellent warm keeping, sandwiched between fabric layers in order to provide an excellent effect of warm keeping.

Various ways are available for bonding the stuffing to the fabric. For example, a sewing line may be formed for the purposes of division or partitioning so that stuffing materials may be stuffed and separated in different partitioned areas. Or, alternatively, the stuffing material may be combined with non-elastic textile to achieve bonding and warm keeping.

The sewing line may somehow or after long term use, present certain gaps or voids, which allows for movement or shift of the stuffing material through the gaps and may lead to the stuffing material penetrating out of the clothing or shifting to a different area. Eventually, the effect of warm keeping achieved with such a product may get deteriorated.

Bonding the stuffing material to non-elastic textile may effectively maintain the effect of warm keeping and make the product sturdy and durable. However, feather clothing made with such an arrangement becomes extremely bulky, making it hard to for a wearer to do activity and also making it hard to apply to manufacturing of skin-contact clothing or underwear.

### SUMMARY OF THE INVENTION

The primary object of the present invention is to provide a feather product that is thinned, shows better fitting to human body and good elasticity to facility movement and enhance warm keeping, and comprises a securely fixed stuffing layer of which feathers are prevented from penetrating out.

To achieve the above object, the present invention provides a feather product that comprises a plurality of elastic fabric layers that is arranged opposite to and corresponding to each other and has elasticity for expandability and/or contractibility. The elastic fabric layers have surfaces that face each other and comprise elastic film layers that has elasticity for expandability and/or contractibility attached thereto and combined therewith. The elastic film layers are combined to each other at localized areas thereof by a plurality of combination sections in a gap-free or void-free manner so that the elastic fabric layers and the elastic film layers delimit therebetween at least one receiving space enclosed thereby. The receiving space receives at least one stuffing layer stuffed and fixed therein. With the elastic film layers attached to and combined with the elastic fabric layers and effectively separating the stuffing layer therefrom, feather penetration of the stuffing may be prevented so that the effect of warm keeping may not get deteriorated. Further, product thinning may be achieved by means of the expandability and contractibility of the elastic fabric layers and the elastic film layers, and constraint resulting from stretching of fabric may not be perceived by a wearer during movement thereof. This technique effectively overcomes the problems of the prior art feather clothing products that the effect of warm keeping gets deteriorated due to movement and outwards penetration of feather, that the movement of a user may be constrained, that the use of the product is not comfortable, and that it is not possible to make skin-contact clothing and provides advantages of stuffing being securely fixed and feather penetration being prevented and product is thinned for better fitting to a user's body and providing enhanced effect of warm keeping and allowing for easy movement of the user.

The foregoing objectives and summary provide only a brief introduction to the present invention. To fully appreciate these and other objects of the present invention as well as the invention itself, all of which will become apparent to those skilled in the art, the following detailed description of the invention and the claims should be read in conjunction with the accompanying drawings. Throughout the specification and drawings identical reference numerals refer to identical or similar parts.

Many other advantages and features of the present invention will become manifest to those versed in the art upon making reference to the detailed description and the accompanying sheets of drawings in which a preferred structural embodiment incorporating the principles of the present invention is shown by way of illustrative example.

### BRIEF DESCRIPTION OF THE DRAWINGS

FIG. 1 is a perspective view showing the present invention.

FIG. 2 is an exploded view of the present invention.

FIG. 3 is a cross-sectional view of the present invention.

FIG. 4 is a schematic view illustrating an example application of the present invention.

FIG. 5 is a schematic view showing the use of the present invention.

FIG. 6 is a cross-sectional view showing another embodiment of the present invention.

FIG. 6A is a cross-sectional view showing a further embodiment of the present invention.

### DETAILED DESCRIPTION OF THE PREFERRED EMBODIMENTS

The following descriptions are exemplary embodiments only, and are not intended to limit the scope, applicability or configuration of the invention in any way. Rather, the following description provides a convenient illustration for implementing exemplary embodiments of the invention. Various changes to the described embodiments may be made in the function and arrangement of the elements described without departing from the scope of the invention as set forth in the appended claims.

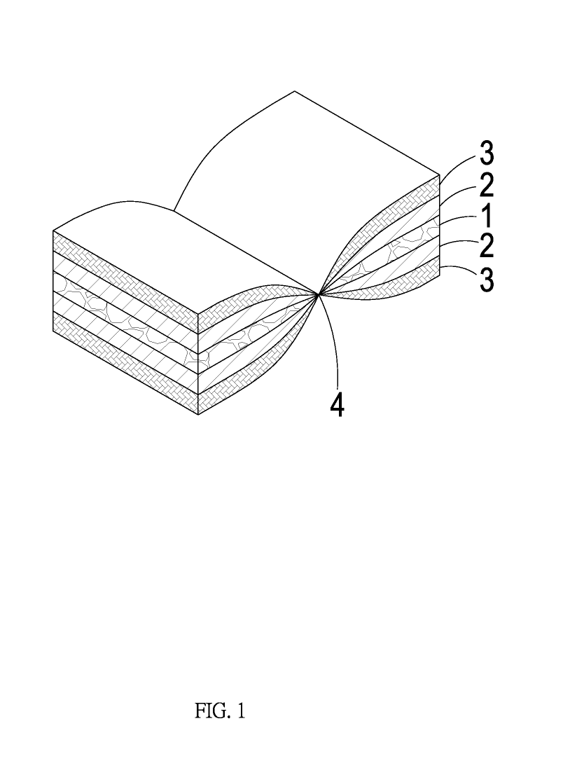

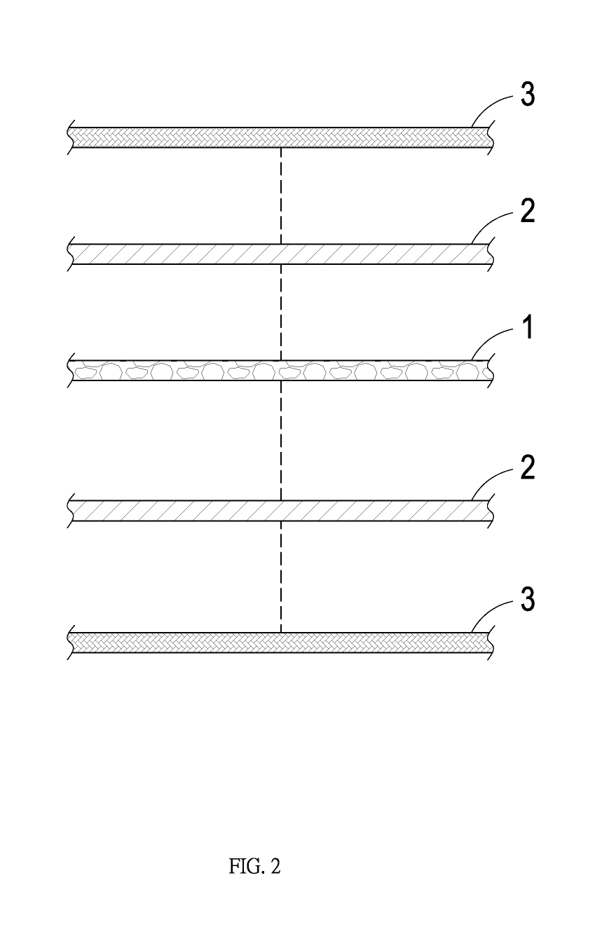

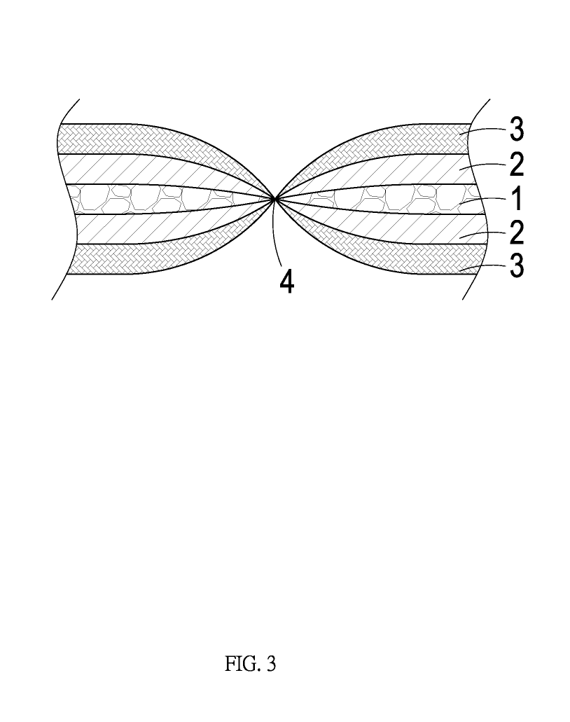

Referring to FIGS. 1-3, the present invention comprises a plurality of elastic fabric layers 3 that has elasticity for expandability and/or contractibility and is arranged opposite to and corresponding to each other, a plurality of elastic film layers 2 that has elasticity for expandability and/or contractibility and is arranged on and combined with surfaces of the elastic fabric layers 3 that face each other, a plurality of combination sections 4 that is formed by combining localized areas of elastic film layers 2 in a gap-free or void-free manner, at least one receiving space delimited between and enclosed by the elastic fabric layers 3 and the elastic film layers 2, and a stuffing layer 1 that is stuffed and fixed in the receiving space.

The elastic fabric layers 3 are one of woven textile, knitted textile, and warp-knitted textile that shows elasticity for expandability and/or contractibility. The elastic fabric layers 3 may comprise a material of spandex. The elastic film layers 2 comprise one of thermoplastic polyurethane (TPU), polyethylene terephthalate (PET), and polytetrafluoroethene (TPFE) and has extensibility of 300%-500% and a thickness of around 0.08 mm-0.15 mm. The elastic film layers 2 comprise a plurality of tiny or micro pores that do not allow the stuffing layer 1 to extend or penetrate therethrough and are combined with the elastic fabric layers 3 through a coating means or an adhering means.

The combination sections 4 are formed by applying a thermal fusion means or a bonding means (by means of hot melt adhesive) to the elastic film layers 2 in such a way that the localized areas of the elastic film layers 2 are permanently and securely and sturdily combined together in a linear form to replace or substitute sewing lines or stitching that are commonly used in prior art products and define the receiving space, with improved aesthetics. The combination sections 4, which are generally linear, have a width of around 0.2 mm-0.5 mm. The stuffing layer 1 is preferably a material comprising feather and/or down.

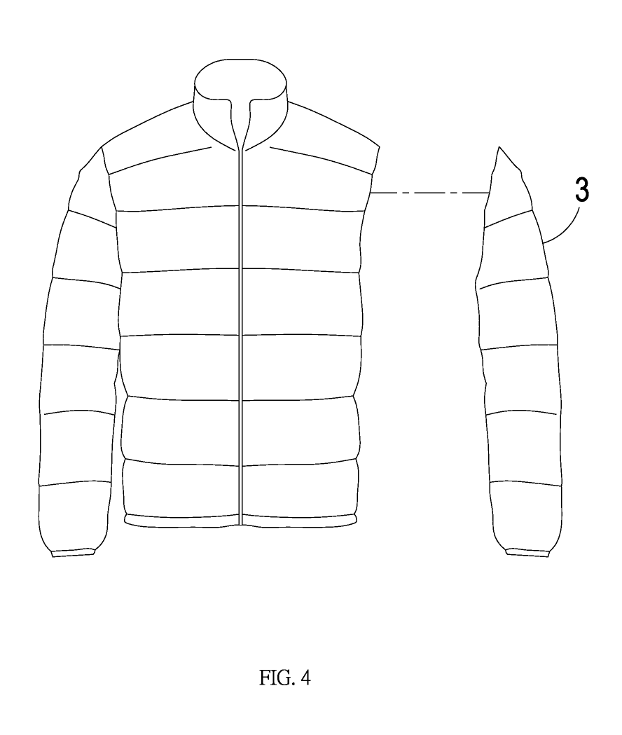

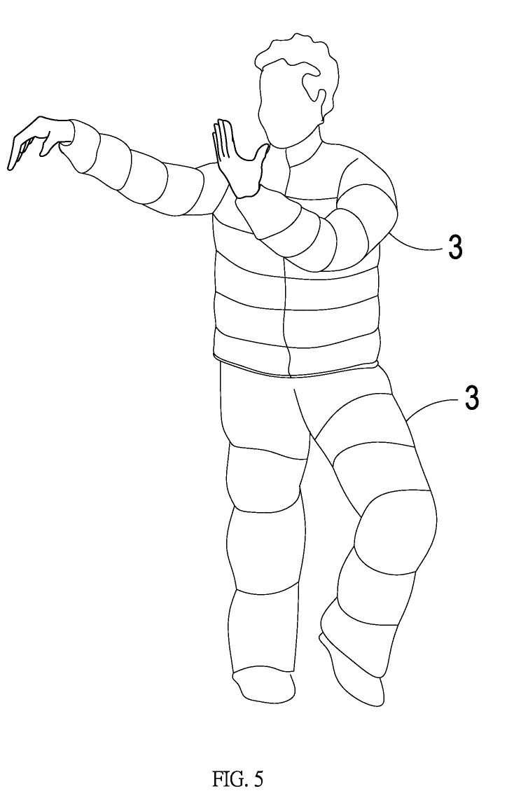

Referring to FIGS. 1-5, manufacturing can be conducted by applying a coating means or an adhering means to have the elastic film layers 2 securely attached to and combined with the elastic fabric layers 3 in such a way that the elastic fabric layers 3 are arranged to respectively correspond to the elastic film layers 2. The stuffing layer 1 is filled and fixed between the elastic film layers 2. Coating means or adhering means is applied to have localized areas of the elastic film layers 2 combined together in a gap-free or void-free manner and showing a linear form that defines each of the combination sections 4.

Since the stuffing layer 1 is enclosed and covered and thus fixed by the elastic film layers 2 and since the elastic film layers 2 are combined together, in the localized areas, in a gap-free or void-free manner by the combination sections 4, the stuffing layer 1 is securely retained in position and movement thereof is prevented and thus, penetration or displacement of feature or down is prevented so that warmth can be effectively kept. Further, since the elastic fabric layers 3 and the elastic film layers 2 are expandable and/or contractible, the product of the present invention can be made thin to provide advantages of better fitting to the user's body and allowing for easy movement. Further, since the elastic film layers 2 comprises a plurality of tiny or micro pores formed therein, circulation of heat can be enhanced to improve the effect of warm keeping, while preventing the feature and/or down of the stuffing layer 1 from penetrating out therethrough.

In addition, before manufacturing, the elastic fabric layers 3 can be tailored to a desired shape for facility subsequent manufacture of any desired products. Further, due to the thinned structure discussed above, the present invention can be widely used in various fields and applications and can be used to produce various products, even including skin-contact clothing, (for example, various feather/down products, including feather underclothing, feather jackets, feature trousers, feather blankets, feather comforters, feather bedding products, feather pads, and down sleeping bags).

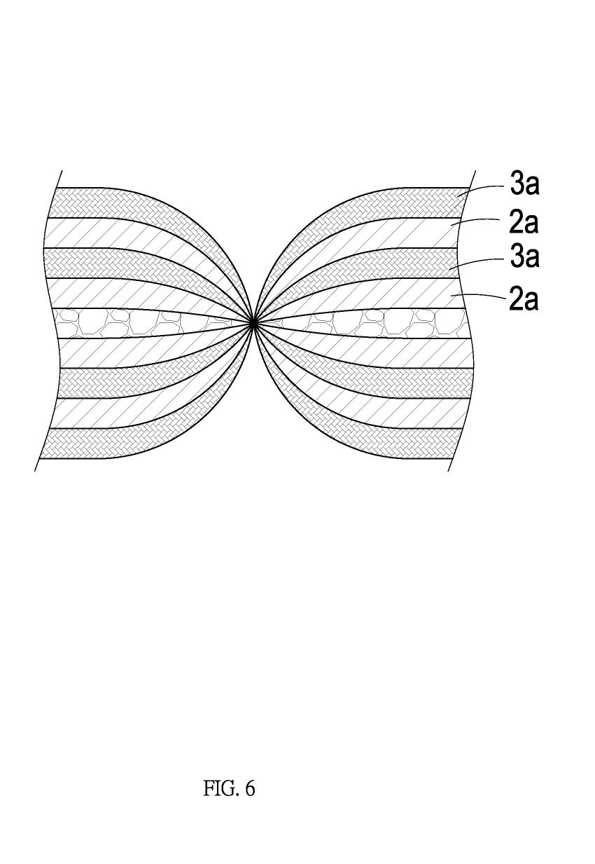

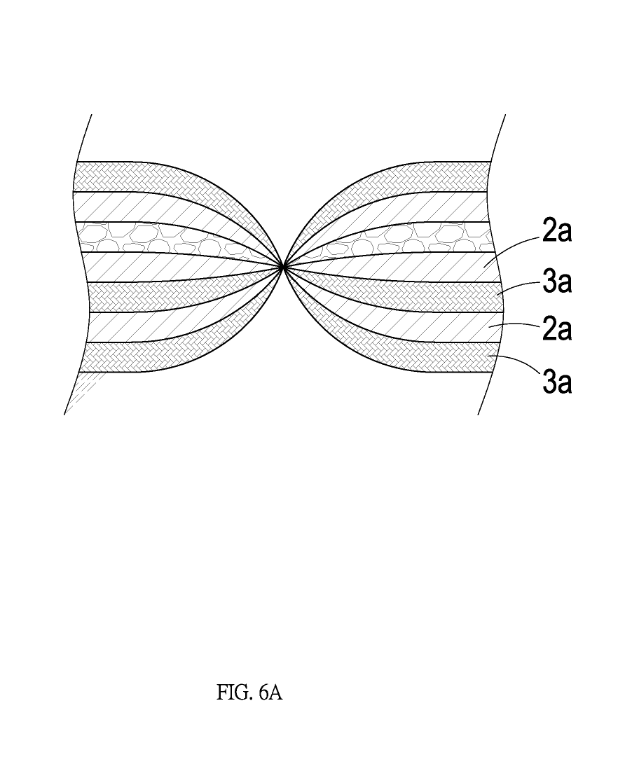

Referring to FIGS. 6 and 6A, another embodiment is illustrated. The instant embodiment is generally similar to the previous embodiment and a difference resides in that the elastic fabric layers 3a each have a surface that is distant from the elastic film layers 2a and comprises an additional elastic film layer 2a and an additional elastic fabric layers 3a sequentially attached thereto so as to show an alternate and stacked arrangement of elastic film layers and elastic fabric layers to provide enhanced elasticity for bettered comfortableness and improved worm keeping effect thereby achieving advantages of better comfortableness and warm keeping.

It will be understood that each of the elements described above, or two or more together may also find a useful application in other types of methods differing from the type described above.

While certain novel features of this invention have been shown and described and are pointed out in the annexed claim, it is not intended to be limited to the details above, since it will be understood that various omissions, modifications, substitutions and changes in the forms and details of the device illustrated and in its operation can be made by those skilled in the art without departing in any way from the claims of the present invention.

I claim:

1. An elastic feature product, comprising:
a plurality of elastic fabric layers, which has elasticity for expandability and/or contractibility and is arranged opposite to and corresponding to each other;
a plurality of elastic film layers, which has elasticity for expandability and/or contractibility and is arranged on and combined with surfaces of the elastic fabric layers that face each other;
a plurality of combination sections, which is formed by combining localized areas of elastic film layers in a gap-free or void-free manner such that at least one the receiving space is delimited between and enclosed by the elastic fabric layers and the elastic film layers; and
at least one stuffing layer, which is stuffed and fixed in the receiving space.

2. The elastic feature product according to claim 1, wherein the elastic fabric layers are one of woven textile, knitted textile, and warp-knitted textile that shows elasticity for expandability and/or contractibility.

3. The elastic feature product according to claim 2, wherein the elastic fabric layers comprise a material of spandex.

4. The elastic feature product according to claim 1, wherein the elastic film layers are attached to and combined with the elastic fabric layers through a coating means or an adhering means.

5. The elastic feature product according to claim 1, wherein the combination sections are formed through thermal fusion or bonding applied to the elastic film layers.

6. The elastic feature product according to claim 1, wherein the elastic film layers comprise one of thermoplastic polyurethane (TPU), polyethylene terephthalate (PET), and polytetrafluoroethene (TPFE).

7. The elastic feature product according to claim 1, wherein the elastic film layers has extensibility of 300%-500%.

8. The elastic feature product according to claim 1, wherein the elastic film layers comprise a plurality of pores formed therein.

9. The elastic feature product according to claim 1, wherein the stuffing layer comprises feather and down.
